(19) United States
(12) Patent Application Publication
(10) Pub. No.: US 2009/0059877 A1
(43) Pub. Date: Mar. 5, 2009

(54) WIRELESS COMMUNICATION DEVICE AND METHOD FOR CONTROLLING WIRELESS COMMUNICATION DEVICE

(75) Inventors: Yoriko Utsunomiya, Ota-ku (JP); Masahiro Takagi, Toshima-ku (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/195,583

(22) Filed: Aug. 21, 2008

(30) Foreign Application Priority Data
Aug. 28, 2007 (JP) 2007-221542

(51) Int. Cl. H04Q 7/24

(52) U.S. Cl. 370/338

(57) ABSTRACT

A wireless communication device includes: a determination unit that determines a selected first and second numbers based on relationship information; a calculation unit that calculates the number of frames transmittable through the first channel within a time period as a first frame number based on the selected first number, and the number of frames transmittable through the second channel within the time period as a second frame number based on the selected second number; a selection unit that selects smaller one of the first and second frame numbers; an aggregation unit that aggregates frames for the selected frame number to generate a single aggregation frame; and a transmission unit that transmits the aggregation frame through one of the first channels or the second channel for which a transmission permission is acquired based on a channel status of the first and the second channels.

The entire disclosure of Japanese Patent Application No. 2007-221542 filed on Aug. 28, 2007 including specification, claims, drawings and abstract is incorporated herein by reference in its entirety.

### FIELD

The present invention relates to a wireless communication device, a method of controlling a wireless communication device, a program for controlling a wireless communication device, and a semiconductor integrated circuit.

### BACKGROUND

Recently, wireless Local Area Networks (LANs) have been rapidly spread not only to offices and hot spot services in public places but also to houses. As wireless LAN specifications, there are IEEE 802.11a using a 5 GHz band and IEEE 802.11b/g using a 2.4 GHz band, as mainstreams. In addition, IEEE 802.11e that additionally expands a Quality of Service (QoS) function is set as standard, and standardization activities for IEEE 802.11n having the object of achieving an effective throughput of 100 Mbps or higher have been progressed.

In IEEE 802.11n, as one approach for achieving high transmission speed, a method of expanding the bandwidth has been proposed. In other words, a bandwidth of 40 MHz is achieved by simultaneously using two channels having the bandwidth of 20 MHz which are generally used in the IEEE 802.11 standard. An example of such technology is disclosed in the related-art document (1) listed below.

The above described wireless communication device that can perform communication by using both bandwidths of 20 MHz and 40 MHz compliant with the IEEE 802.11n standard can select for each frame whether to communicate through one channel having the bandwidth of 20 MHz or to communicate through both channels having the bandwidth of 40 MHz.

However, in the above described wireless communication device, the bandwidth that can be used for frame transmission may be shifted from 40 MHz to 20 MHz just before starting to transmit a frame (see related-art document (2), for instance).

### List of Related-Art Documents

EWC MAC Specification Version V1.24 Jan. 5, 2006, <URL:http://www.enhancedwirelessconsortium.org/> on the Internet (1)

WWiSE, “WWiSE Proposal: High throughput extension to the 802.11 Standard”, WWiSE Draft, August 2004 (2)

“Yasuyuki NISHIBAYASHI, Yoriko UTSUNOMIYA, and Masahiro TAKAGI, Proposal for MAC Frame Aggregation Method Using Selective Re-transmission Control in Wireless LAN, Technical Report of the Institute of Electronics, Information and Communication Engineers (IEICE) Vol. 104, No. 438, IN2004-113, pp. 31-36, November 2004” (3)

A wireless communication device starts to transmit a frame after waiting for a time (backoff time) before frame transmission. In addition, the wireless communication device, in order to achieve a high throughput, can aggregate a plurality of frames and then performs frame transmission.

The wireless communication device, in order to transmit aggregation frames instantly after the backoff time elapses, performs a frame aggregating process and the like in the middle of the backoff time in advance. The number of aggregation frames in the frame aggregating process is the number of frames that can be transmitted within a period (TXOP: transmission opportunity) in which the channel can be continuously occupied.

Here, in a case where communication using the bandwidth of 40 MHz has been planned, when the bandwidth is shifted to 20 MHz just before starting the frame transmission, the period in which the channel can be continuously occupied ends in the middle of transmitting the frames aggregated by the wireless communication device.

On the other hand, when only frames of a small number are aggregated such that the aggregation frames can be transmitted within the period in which the channel can be continuously occupied even in a case where the bandwidth is shifted to 20 MHz, for example, a half of the period in which the channel can be continuously occupied is not used to remain when communication using the bandwidth of 40 MHz can be performed, and thereby the throughput is degraded.

### SUMMARY

According to one aspect of the invention, a wireless communication device that performs transmission and reception of frames by occupying one of two first channels having the same bandwidth or by occupying a second channel including both of the first channels for a given time period, the device includes: a determination unit that determines a first status representing whether at least one of the first channels is in a busy state or in an idle state and a second status representing whether the second channel is in a busy state or in an idle state; an acquisition unit that acquires a transmission permission for the first channel or the second channel based on the first status and the second status; a storage unit that stores relationship information used for determining a relationship between first numbers and second numbers, the first numbers being used for determining a modulation scheme and a coding scheme for transmitting the frame through the first channel, the second numbers being used for determining a modulation scheme and a coding scheme for transmitting the frame through the second channel; a first determination unit that determines a selected second number used for transmitting the frame through the second channel from among the second numbers; a second determination unit that determines a selected first number corresponding to the selected second number based on the relationship information; a first calculation unit that calculates the number of frames that are transmittable through the first channel within the given time period as a first frame number based on a transmission rate that is determined from the selected first number; a second calculation unit that calculates the number of frames that are transmittable through the second channel within the given time period as a second frame number based on a transmission rate that is determined from the selected second number; a selection unit that selects smaller one of the first frame number and the second frame number; an aggregation unit that aggregates frames for the selected frame number selected by the selection unit to generate a single aggregation frame before the acquisition unit acquires the transmission permission; and a transmission unit that transmits the aggregation frame through one of the first channels or the second channel for which the transmission permission is acquired.

### BRIEF DESCRIPTION OF THE DRAWINGS

Embodiment may be described in detail with reference to the accompanying drawings, in which:

FIG. 1 is a block diagram showing the configuration of a wireless communication system according to an embodiment of the invention;

FIGS. 2A and 2B are block diagrams showing frequency bandwidths of first and second channels according to the embodiment;

FIG. 3 is a block diagram showing the configuration of a wireless communication device according to the embodiment;

FIG. 4 is a diagram showing an MCS table of the first channel having the bandwidth of 20 MHz according to the embodiment;

FIG. 5 is a diagram showing an MCS table of the second channel having the bandwidth of 40 MHz according to the embodiment;

FIGS. 6A and 6B are schematic diagrams showing a case where the aggregation frame is transmitted through the first and second channels;

FIG. 7 is a diagram showing an MCS correspondence table according to the embodiment;

FIGS. 8A and 8B are diagrams showing a situation in which a transmission permission for the first channel (bandwidth 20 MHz) is acquired;

FIGS. 9A and 9B are diagrams showing a situation in which a transmission permission for the second channel (bandwidth 40 MHz) is acquired;

FIG. 10 is a flowchart showing the operation of a wireless communication device according to the embodiment;

FIG. 11 is a schematic diagram showing a case where the aggregation frame is transmitted through the second channel; and

FIG. 12 is a schematic diagram showing a case where the aggregation frame is transmitted through the first channel.

### DETAILED DESCRIPTION

Hereinafter, embodiment (s) of the present invention will be described.

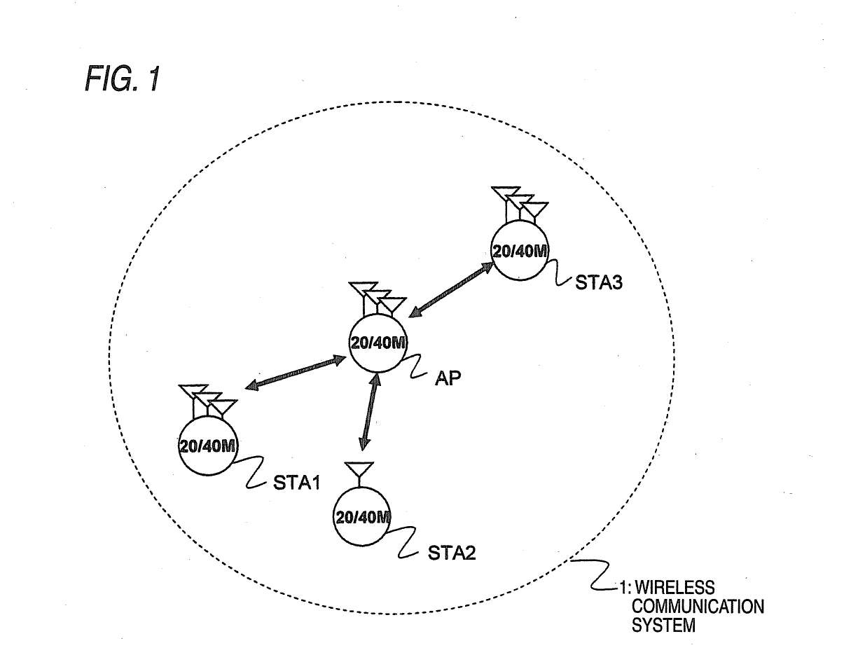

FIG. 1 is a block diagram showing the configuration of a wireless communication system 1 according to the embodiment.

The wireless communication system 1 according to the embodiment includes one access point AP and three wireless communication devices STA1, STA2, and STA3 and configures one Basic Service Set (BSS).

In the wireless communication system 1, communication is performed by using two types of frequency bands including a first channel having a bandwidth of 20 MHz and a second channel having a bandwidth of 40 MHz.

The access point AP and the wireless communication devices STA1 and STA3 perform communication by using both the first channel having a bandwidth of 20 MHz and the second channel having a bandwidth of 40 MHz. The access point AP and the wireless communication devices STA1 and STA3 have a plurality of antennas and accept Multi Input Multi Output (MIMO).

The wireless communication device STA2 performs communication by using both the first channel having a bandwidth of 20 MHz and the second channel having a bandwidth of 40 MHZ. The wireless communication device STA2 has one antenna and accept Single Input Single Output (SISO). According to the present invention, the bandwidths of the first and second channels and the number of antennas of each wireless communication device are not limited to those described above.

The wireless communication system 1 is compliant with IEEE 802.11n standards. The wireless communication system 1 may be compliant with IEEE Std. 802.11-1999 (revision 2003 includes ISO/IEC 8802-11:1999(E) ANSI/IEEE Std 802.11, 1999 edition, IEEE Std 802.11a-1999, IEEE Std 802.11b-1999, IEEE Std 802.11b-1999/Cor 1-2001 and IEEE Std 802.11d-2001). The IEEE 802.11 standards include amendments, recommended practices, and the like of the IEEE 802.11 standards.

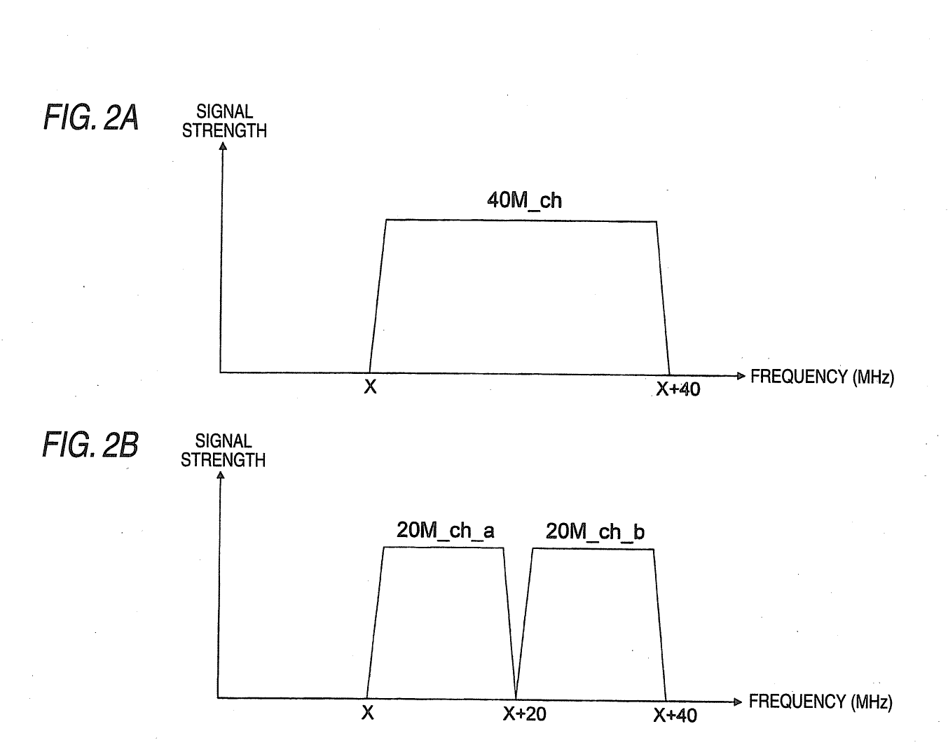

FIGS. 2A and 2B are schematic diagrams of channels used in the wireless communication system 1. A channel 40M_ch shown in FIG. 2A is the second channel. A channel 20M_ch_a shown in FIG. 2B is the first channel.

The first channel 20M_ch_a has a bandwidth of 20 MHz and is configured by a frequency band of X MHz to (X+20) MHz. A channel 20M_ch_b has a bandwidth of 20 MHz and is configured by a frequency band of (X+20) MHz to (X+40) MHz. The second channel 40M_ch has a bandwidth of 40 MHz and is configured by a frequency band of X MHz to (X+40) MHz. The second channel 40M_ch is configured by the first channel 20M_ch_a and the channel 20M_ch_b.

The frequency band of X MHz to (X+20) MHz is used commonly as the first channel and as the second channel. In the BSS configured by the wireless communication system 1, the first channel 20M_ch_a is referred to as a primary channel and is used for communication using the bandwidth of 20/40 MHz and exchange of control information for managing the BSS.

The frequency band of (X+20) MHz to (X+40) MHz is used as the second channel. In the BSS configured by the wireless communication system 1, the channel 20M_ch_b is referred to as a secondary channel and is used for communication using the bandwidth of 40 MHz.

In the BSS configured by the wireless communication system 1, the frequency band of (X+20) MHz to (X+40) MHz is not used for communication having the bandwidth of 20 MHz. However, another wireless communication system 1 or another BSS may use the above-described frequency band for communication having the bandwidth of 20 MHz. In particular, in a wireless communication system or a BSS that uses only a bandwidth of 20 MHz called IEEE 802.11/a/b/g, there is a case where communication having the bandwidth of 20 MHz is performed by using a same frequency band as that of the channel 20M_ch_b.

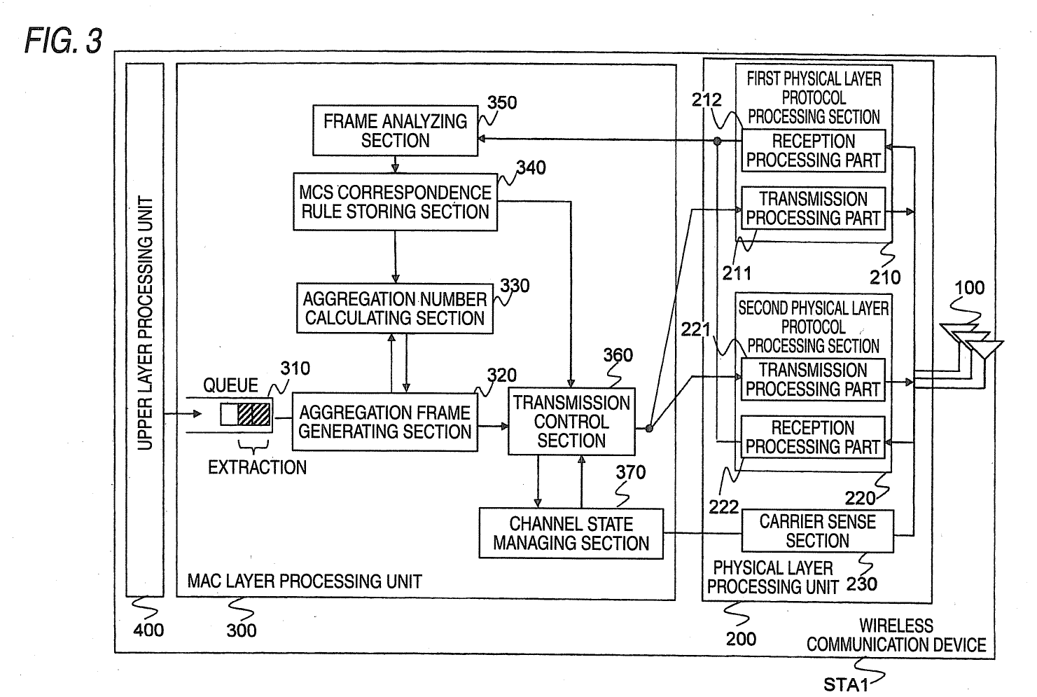

FIG. 3 is a block diagram showing the configuration of the wireless communication device STA1. The configuration of the access point AP or the wireless communication device STA3 is the same as that of the wireless communication device STA1. The wireless communication device STA2 has only one antenna and a unique process section that performs a frame transmitting/receiving process corresponding to the antenna, which is different from the wireless communication device STA1. However, the other configurations of the wireless communication device STA2 are the same as those of the wireless communication device STA1.

The wireless communication device STA1 includes an antenna 100, a physical layer processing unit 200, a Media Access Control (MAC) layer processing unit, and an upper layer processing unit 400. First, the configuration of the physical layer processing unit 200 will be described, and then, the configuration of the MAC layer processing unit 300 will be described.

The physical layer processing unit 200 has a first physical layer protocol processing section 210, a second physical layer protocol processing section 220, and a carrier sense section 230. The first physical layer protocol processing section 210 has a reception processing part 212 and a transmission processing part 211. The first physical layer protocol processing section 210 performs a frame transmitting/receiving operation through the first channel 20M_ch_a. The second physical layer protocol processing section 220 has a reception processing part 222 and a transmission processing part 221. The second physical layer protocol processing section 220 performs a frame transmitting/receiving operation through the second channel 40M_ch. The first physical layer protocol processing section 210 and the second physical layer protocol processing section 220 may be built in a common circuit.

The first physical layer protocol processing section 210 processes at least a physical layer protocol defined by IEEE 802.11a for performing communication through a channel having a bandwidth of 20 MHz. In addition, the first physical layer protocol processing section may have a function for processing another physical layer protocol such as IEEE 802.11n. The first physical layer protocol processing section accepts SISO technology that uses one antenna 100 for a frame transmitting/receiving operation and Multiple Input Multiple Output (MIMO) technology that uses a plurality of antennas 100 for a frame transmitting/receiving operation.

The second physical layer protocol processing section 220 processes a physical layer protocol defined by IEEE 802.11n for performing communication through a channel having a bandwidth of 40 MHz. In addition, the second physical layer protocol processing section 220 may have a function for processing another physical layer protocol. The second physical layer protocol processing section 220 accepts SISO technology and Multiple Input Multiple Output (MIMO) technology.

The carrier sense section 230 determines whether the first channel 20M_ch_a, the channel 20M_ch_b, and the second channel 40M_ch are in a busy state (BUSY) or in an idle state (IDLE), based on the power levels of signals received by the antenna 100.

The carrier sense section 230 individually determines whether the above-described channels are in a busy state or in an idle state by using a filter that extracts only a signal of a certain frequency band. The carrier sense section 230, in order to remove the influence of noises, measures the power levels of signals received by the antenna 100 for a certain time, and, for example, sets an average value of measurement results to the strength of the received signal. The carrier sense section 230 determines that a channel is BUSY when the strength of the received signal is higher than a threshold value. On the other hand, the carrier sense section 230 determines that a channel is IDLE when the strength of the received signal is equal to or lower than the threshold value. Here, the threshold value may be set dynamically corresponding to the peripheral situation of the wireless communication device such as existence of interference, or may be set statically. The carrier sense section 230 transmits carrier sense information that represents whether each channel is BUSY or IDLE to a channel state managing section 370 of the MAC layer processing unit 300.

In addition, the threshold value may be different values in a case where the received signal includes a physical header and can be regarded as a significant signal and in a case where the received signal cannot be regarded as a significant signal and is considered to be an insignificant signal. This method is defined in “CCA”, “CCA Sensitivity”, and “Receive PLCP” Sections of IEEE 802.11a. In IEEE 802.11a, for the first channel 20M_ch_a having a bandwidth of 20 MHz, the threshold value of the significant signal is set to −82 [dBm], and the threshold value of the insignificant signal is set to −62 [dBm].

The MAC layer processing unit 300 has a queue 310, an aggregation frame generating section 320, an aggregation number calculating section 330, an MCS correspondence rule storing section 340, a frame analyzing section 350, a transmission control section 360, and a channel state managing section 370. The MAC layer processing unit 300 processes data that has been received from the upper layer processing unit 400.

The queue 310 uses a First In First Out (FIFO) method and sequentially stores data received from the upper layer processing unit 400 as MAC frames.

The aggregation frame generating section 320 aggregates a plurality of MAC frames stored in the queue 310 so as to generate an aggregation frame (aggregation frame: Aggregated MAC Protocol Data Unit (A-MPDU)). The aggregation frame is processed as one MAC frame by the physical layer processing unit 200. Technology (frame aggregation technology) for aggregating the frames is, for example, described in the related-art document (3) listed above.

The aggregation number calculating section 330 calculates the aggregation number of MAC frames that are aggregated for generating the aggregation frame by the aggregation frame generating section 320. The aggregation number calculating section 330 calculates the number of aggregations of MAC frames based on the transmission rates, periods in which channels can be continuously occupied, and sizes of MAC frames of the first channel 20M_ch_a and the second channel 40M_ch.

The aggregation number calculating section 330 calculates the aggregation number of the MAC frames such that transmission can be performed within the period, in which the channel can be continuously occupied, in a case where the aggregation frame is transmitted using the first channel 20M_ch_a or the second channel 40M_ch.

The transmission rates of the first channel 20M_ch_a and the second channel 40M_ch are determined based on multiple factors including a Modulation and Coding Scheme (MCS) table (MCS number) in IEEE 802.11n, a frequency bandwidth, the length of a guard interval, and the like.

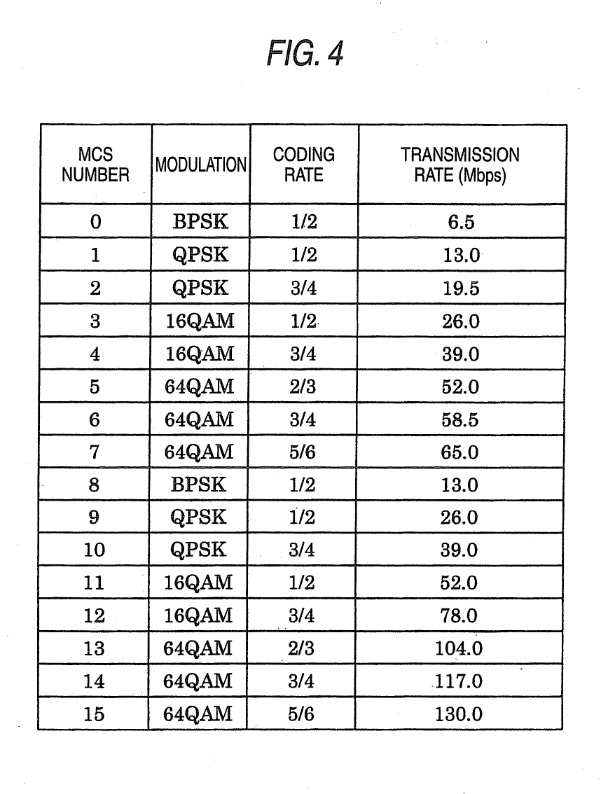

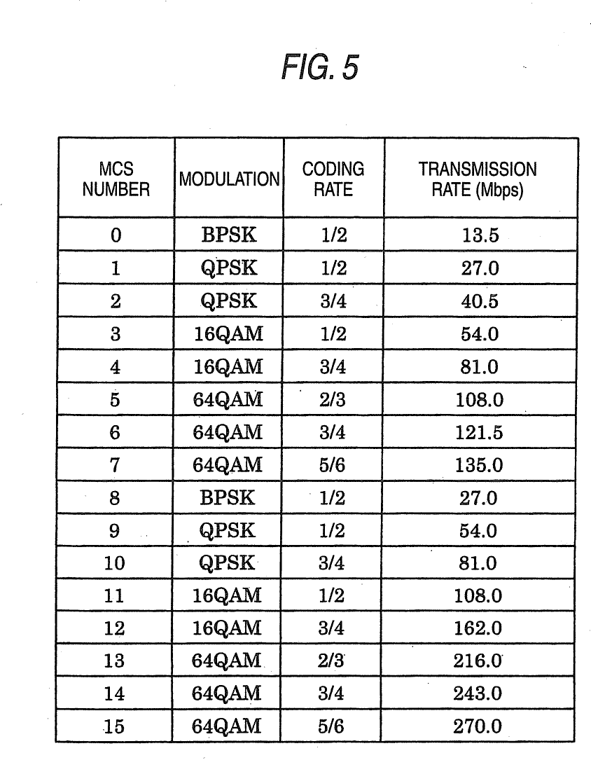

FIG. 4 is a diagram showing an example of an MCS table of the first channel 20M_ch_a (bandwidth 20 MHz). FIG. 5 is a diagram showing an example of an MCS table of the second channel 40M_ch (bandwidth 40 MHz). The MCS table defines a modulation method, a coding rate, and a transmission rate based on the MCS number. The coding rate is defined as (number of bits representing information)/(number of bits after an error correction encoding process). The MCS table is stored in a storage part such as a storage part built in the aggregation number calculating section 330 that can be accessed from the aggregation number calculating section 330.

The period in which a channel can be continuously occupied becomes a transmission opportunity (TXOP) of IEEE 802.11e standards. The TXOP is a period in which a frame can be transmitted, after the wireless communication devices acquire transmission right, by continuously occupying a channel of which transmission right is acquired. In IEEE 802.11e standards, the default value of the TXOP is defined for each traffic type (AC: Access Category). For example, when the AC is Voice, the default value of the TXOP is 3 milliseconds. On the other hand, when the AC is Video, the default value of the TXOP is 5 milliseconds.

A value informed to each wireless communication device from the access point AP may be used as the period in which a channel can be continuously occupied.

Hereinafter, an example of calculation of the aggregation number of the MAC frames by using the aggregation number calculating section 330 will be described. It is assumed that the MCS number of the first channel in wireless communication is 13 (64 quadrature amplitude modulation (QAM), ⅔), the MCS number of the second channel in wireless communication is 11 (16 QAM, ½), the size of the MAC frame is 1500 bytes, and a period in which a channel can be continuously occupied is 3 milliseconds.

The transmission rate in the physical layer of the first channel 20M_ch_a (bandwidth 20 MHz) becomes 104 [Mbps] based on the MCS number of 13 in the MCS table shown in FIG. 4. The transmission rate in the physical layer of the second channel 40M_ch (bandwidth 40 MHz) becomes 108 [Mbps] based on the MCS number of 11 in the MCS table shown in FIG. 5.

The aggregation number calculating section 330 acquires the number n (n is an integer equal to or larger than one) of frames that can be transmitted within the period, in which a channel can be continuously occupied, as a maximum value of n that satisfies a relational expression of (period in which a channel can be continuously occupied)≧(a time required for transmitting n MAC frames)=(size of the MAC frame×n)/transmission rate.

The number n₂₀ of frames for which transmission is completed within the period, in which a channel can be continuously occupied, in a case where the MAC frames are transmitted by using the first channel 20M_ch_a is acquired as a maximum value of n₂₀ that satisfies a relational expression of (period in which a channel can be continuously occupied: 3 msec)≧(size of MAC frame: 1500 bytes×n₂₀)/(transmission rate: 104 Mbps). From the relational expression described above, 26 is acquired as n₂₀.

In addition, the number n₄₀ of frames for which transmission is completed within the period, in which a channel can be continuously occupied, in a case where the MAC frames are transmitted by using the second channel 40M_ch is acquired as a maximum value of n₄₀ that satisfies a relational expression of (period in which a channel can be continuously occupied: 3 msec)≧(size of MAC frame: 1500 bytes×n₄₀)/(transmission rate: 108 Mbps). From the relational expression described above, 27 is acquired as n₄₀.

In addition, the MCS numbers of the first and second channels in wireless communication are determined in accordance with the MCS correspondence table stored in the MCS correspondence rule storing section 340.

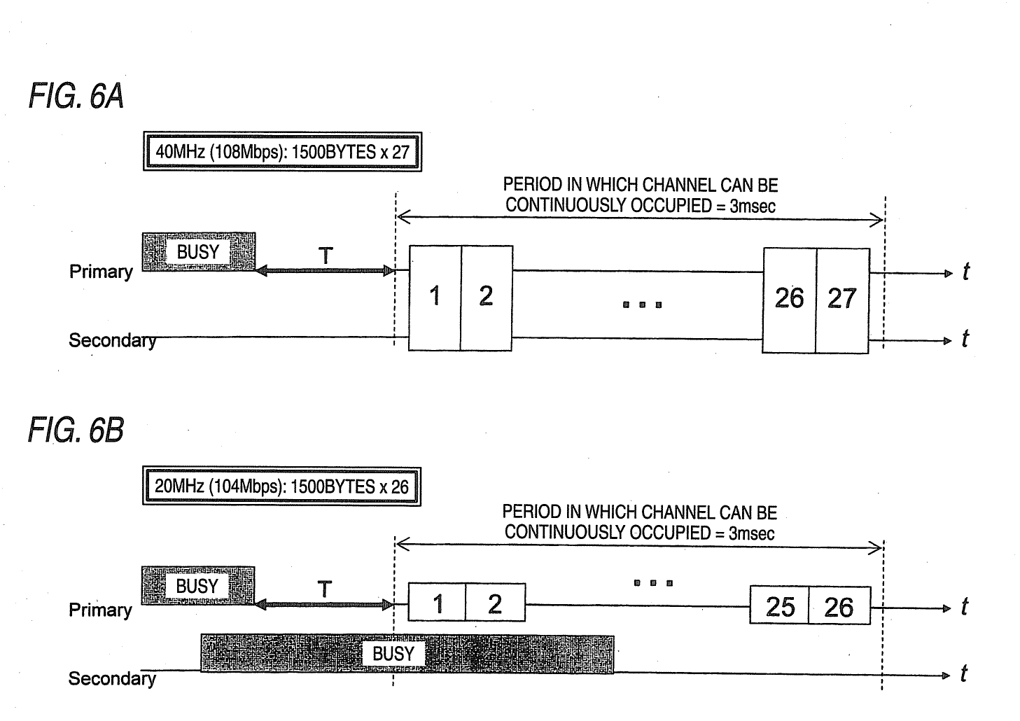

FIG. 6A shows a schematic diagram in a case where an aggregation frame in which n₂₀ MAC frames are aggregated is transmitted by using the first channel 20M_ch_a and FIG. 6B shows a schematic diagram in a case where an aggregation frame in which n₄₀ MAC frames are aggregated is transmitted by using the second channel 40M_ch. As shown in FIGS. 6A and 6B, in the case where the aggregation frame in which n₂₀ MAC frames are aggregated is transmitted by using the first channel 20M_ch_a and in the case where the aggregation frame in which n₄₀ MAC frames are aggregated is transmitted by using the second channel 40M_ch, transmission of the aggregation frame is completed within the period in which the channel can be continuously occupied and the remaining time of the period in which the channel can be continuously occupied is not so long.

The MCS correspondence rule storing section 340 stores an MCS correspondence table that defines a relationship between an MCS number in a case where wireless communication is performed by using the second channel 40M_ch and an MCS number in a case where wireless communication is performed by using the first channel 20M_ch_a.

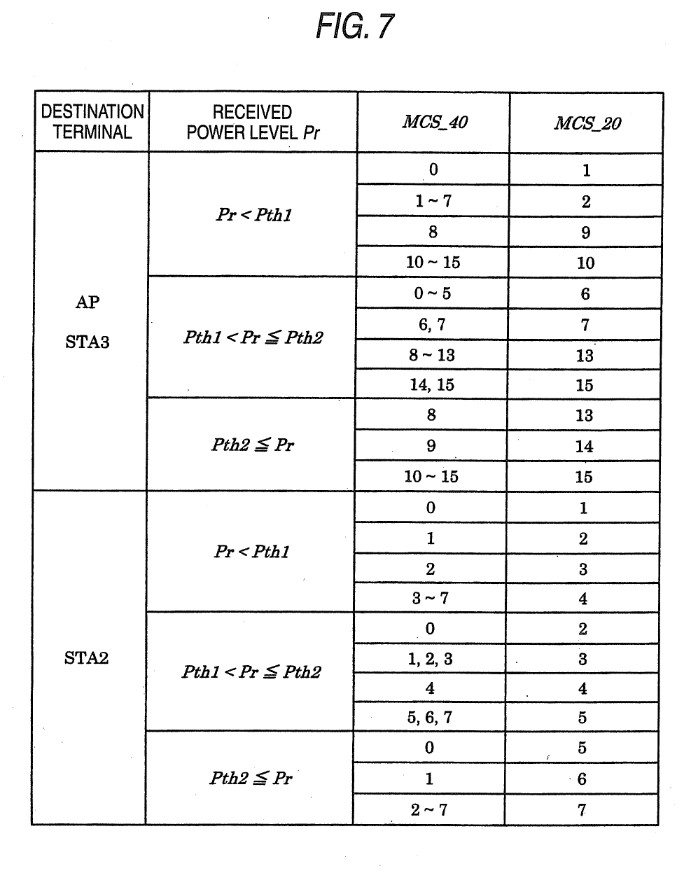

FIG. 7 is a diagram showing an example of the MCS correspondence table. The MCS correspondence table defines sets of a first MCS number and a second MCS number such that effective throughputs of the first and second channels in wireless communication become substantially equivalent to each other.

The actual throughput is not the transmission speed (ideal throughput) in the MCS table shown in FIGS. 4 and 5 but a transmission speed with the frame error rate, for example, that could be predicted from the received power level, the error rate and the like of frames received in the past.

In addition, since the energy levels per bit for the second channel 40M_ch having the bandwidth of 40 MHz and the first channel 20M_ch_a having the bandwidth of 20 MHz are different due to different bandwidths, it is considered for calculating the actual throughput that the error rate of the second channel having the bandwidth of 40 MHZ is larger than that of the first channel even for a same MCS number.

Different MCS correspondence tables may be set for the access point AP and the wireless communication devices STA2 and STA3. The MCS correspondence table may be updated based on the received power level, the error rate, and the like of a frame received from each device.

In IEEE 802.11n standards, for the MCS numbers of 0 to 7, wireless communication using SISO is performed. In addition, for the MCS numbers of 8 to 15, wireless communication using MIMO is performed.

Since the wireless communication devices STA1 and STA3 and the access point AP have a plurality of antennas 100, they perform wireless communication by using the MCS numbers of 0 to 15. On the other hand, since the wireless communication device STA2 has one antenna, it performs wireless communication by using the MCS numbers of 0 to 7. The MCS correspondence table shown in FIG. 7 has different values for a case where the destination of a MAC frame is the wireless communication device STA3 or the access point AP that has a plurality of antennas 100 and a case where the destination of a MAC frame is the wireless communication device STA2 that has one antenna.

Within a group of the MCS numbers of 0 to 7 or a group of the MCS numbers of 8 to 15, when the MCS number has a small value, the actual throughput is low even in a case where the channel environment is good. However, when the channel environment is degraded, the actual throughput does not decrease so significantly. On the other hand, when the MCS number has a large value, the actual throughput is high in a case where the channel environment is good. However, when the channel environment is degraded, the actual throughput easily decreases. The channel environment can be predicted based on the received power level of the received frame or the frame error rate thereof. In the embodiment, the channel environments are divided into three by using the average of the received power levels of received frames which is acquired by the frame analyzing section 350 and two threshold values Pth1 and Pth2 (where Pth1<Pth2)

The MCS correspondence table shown in FIG. 7 has different values for a case where the average of the received power levels of the received frames which is acquired by the frame analyzing section 350 is equal to or smaller than Pth1, a case where the average is larger than Pth1 and equal to or smaller than Pth2, and a case where the average is larger then Pth2.

The frame analyzing section 350 analyzes frames received from reception processing parts 212 and 222 of the first and second physical layer protocol processing sections 210 and 220. The frame analyzing section 350 calculates an average of received power levels of frames received from the wireless communication device STA3 and the access point AP and an average of received power levels of frames received from the wireless communication device STA2. The average of the received power levels is calculated as an average value of received power levels of frames that have been received in a certain period. The certain period for calculating the average of the received power levels of frames, for example, may be a period from time when a wireless communication device receives a frame from another wireless communication device for the first time to time when a frame is received thereafter, or may be one beacon interval.

The channel state managing section 370 manages the busy/idle states of the first channel 20M_ch_a and the second channel 40M_ch by using the carrier sense information received from the carrier sense section 230. In other words, the channel state managing section 370 determines the busy/idle state of the first channel 20M_ch_a and the second channel 40M_ch by using the carrier sense information measured by the carrier sense section of the physical layer processing unit and virtual carrier sense information acquired by the MAC layer protocol. The virtual carrier sense information is information for representing the busy/idle state of a wireless channel determined by using information on whether it is a period in which a Network Allocation Vector (NAV) is set by another wireless communication device.

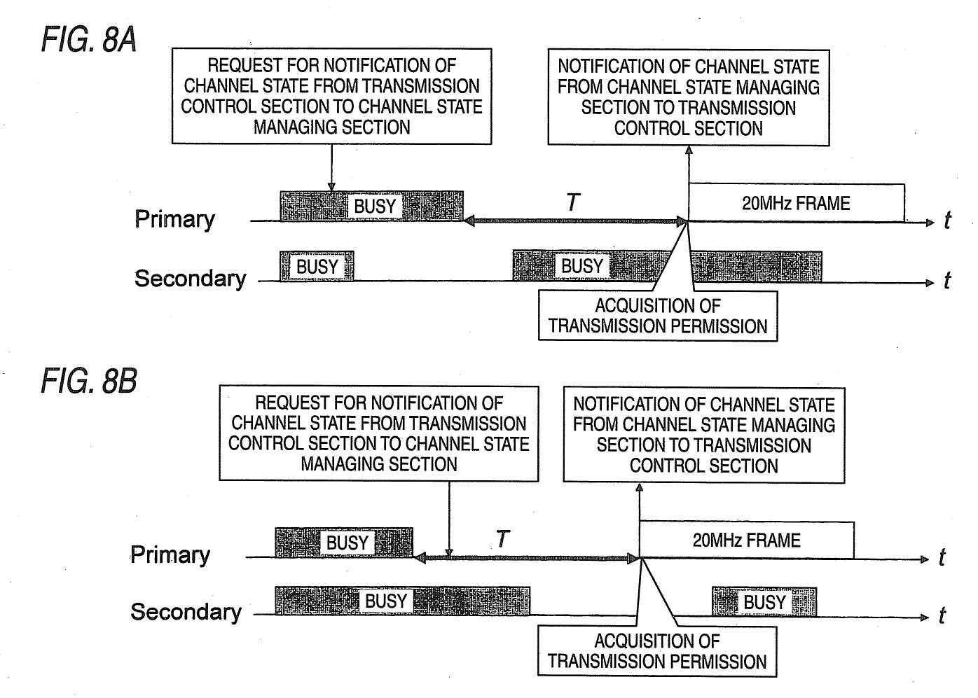

FIGS. 8A and 8B are diagrams showing a situation in which a transmission right for the first channel 20M_ch_a (bandwidth 20 MHz) is acquired.

When receiving a request for notification of the state of the first channel 20M_ch_a from the transmission control section 360, the channel state managing section 370 checks the idle (IDLE)/busy (BUSY) state of only the first channel 20M_ch_a. When detecting the idle state of the first channel 20M_ch_a for a time T, the channel state managing section 370 transmits a signal that represents the idle state (acquisition of a transmission right) of the first channel 20M_ch_a back to the transmission control section 360. In addition, as shown in FIGS. 8A and 8B, when continuously detecting the idle state of the first channel 20M_ch_a for over the time T, the channel state managing section 370 transmits a signal that represents the idle state (acquisition of the transmission right) of the first channel 20M_ch_a back to the transmission control section 360, regardless whether the first channel 20M_ch_b is in the busy or idle state at a time when the request for notification of the state of the first channel 20M_ch_a is received.

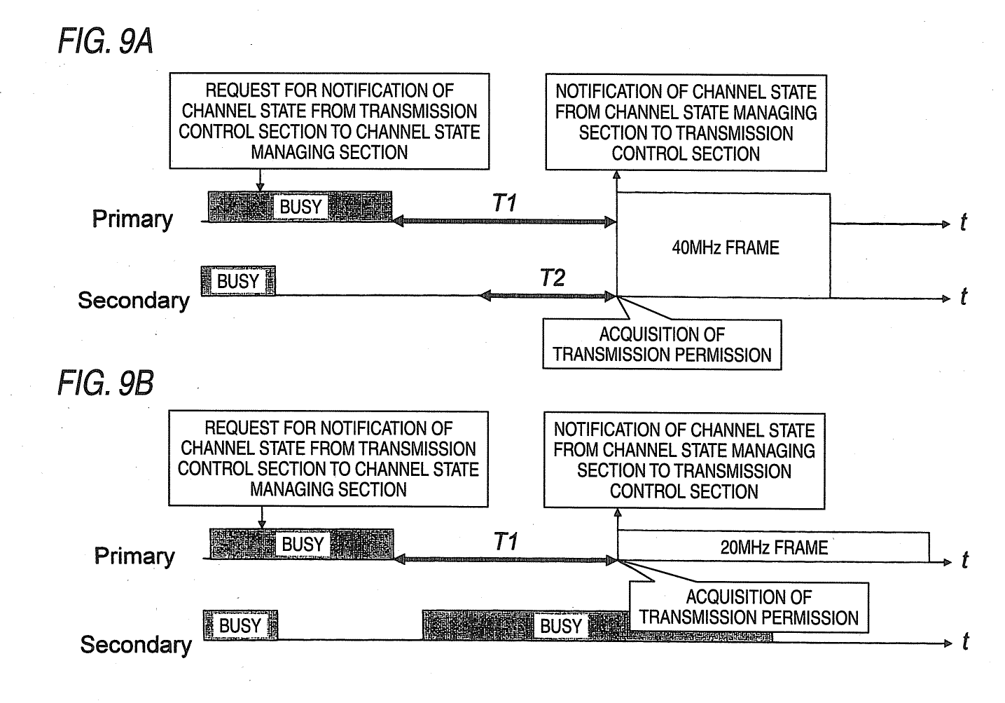

FIGS. 9A and 9B are diagrams showing a situation in which a transmission right for the second channel 40M_ch (bandwidth 40 MHz) is acquired.

When receiving a request for notification of the state of the second channel 40M_ch from the transmission control section 360, the channel state managing section 370 checks the idle (IDLE)/busy (BUSY) states of the first channel 20M_ch_a and the second channel 40M_ch.

As shown in FIG. 9A, when detecting the idle state of the first channel 20M_ch_a for a time T1 and the idle state of the second channel 40M_ch for a time T2, the channel state managing section 370 transmits a signal that represents the idle state (acquisition of the transmission right) of the second channel 40M_ch back to the transmission control section 360.

As shown in FIG. 9B, when the idle state of the first channel 20M_ch_a for the time T1 is detected and the idle state of the second channel 40M_ch for the time T2 is not detected, the channel state managing section 370 transmits a signal that represents the idle state (acquisition of the transmission right) of the first channel 20M_ch_a back to the transmission control section 360.

As described above, even when the channel state managing section 370 receives the request for notification of the state of the second channel 40M_ch from the transmission control section 360, there is a case where the channel state managing section 370 transmits not only the signal representing the idle state (acquisition of the transmission right) of the second channel 40M_ch but also the idle state (acquisition of the transmission right) of the first channel 20M_ch_a as a response to the request. In addition, the relationship of 0<T2 [μsec]≦T1 [μsec] is satisfied. The transmission control section 360 serves as an acquisition unit.

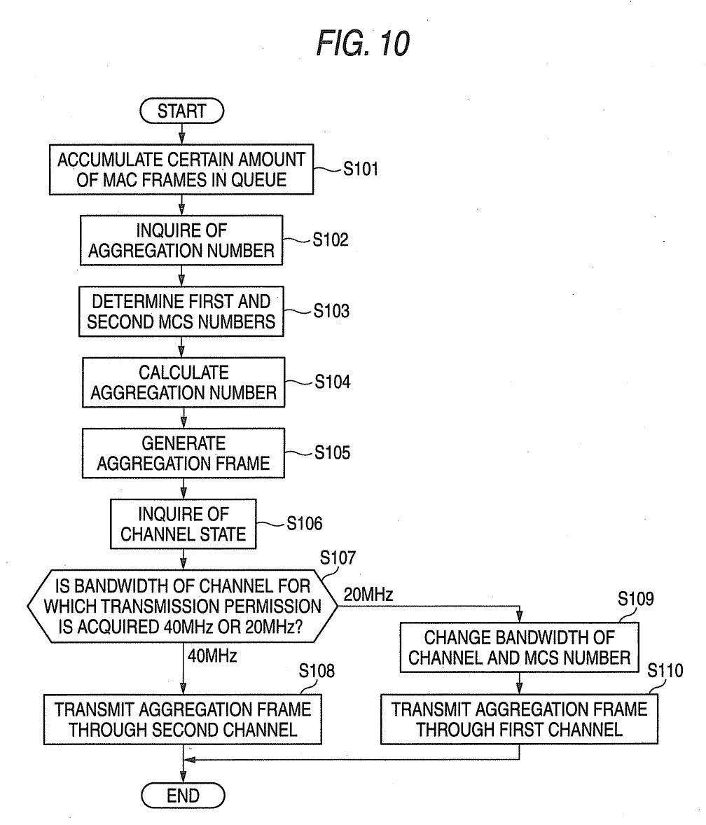

FIG. 10 is a flowchart showing the operation of the wireless communication device.

First, the MAC layer processing unit 300 receives data from the upper layer processing unit 400. In the MAC layer processing unit 300, a MAC header is added to the data transmitted from the upper layer processing unit 400, and the data is stored as a MAC frame in the queue 310. It is assumed that the MAC frame stored in the queue 310 is transmitted through the second channel 40M_ch. In addition, for a MAC frame transmitted through the first channel 20M_ch_a, a different transmission process is performed.

The queue 310 continues to store the MAC frames. When the amount of the stored MAC frames is equal to or larger than a certain amount, the queue 310 notifies the aggregation frame generating section 320 that the certain amount of the MAC frames are stored (Step S101). Here, the certain amount is an integer equal to or greater than one. In the notification process, the queue 310 transmits a transmission destination address of the MAC frames, additionally. Here, it is assumed that the destination address of the MAC frames stored in the queue 310 is the address of the wireless communication device STA3.

Next, the aggregation frame generating section 320 inquires the aggregation number calculating section 330 of the aggregation number of the MAC frames for generating an aggregation frame (Step S102). In the inquiry process of the aggregation number of the MAC frames, the aggregation frame generating section 320 transmits the transmission destination address that has been received from the queue 310 with above inquiry.

Next, the aggregation number calculating section 330 determines an MCS number (first MCS number) used in communication using the first channel 20M_ch_a and an MCS number (second MCS number) used in communication using the second channel 40M_ch.

The aggregation number calculating section 330 determines the second MCS number, which is used in transmission of MAC frames, based on the state (the states of the first channel 20M_ch_a and the second channel 40M_ch) of a route up to the wireless communication device STA3, which is the destination of the MAC frame, and the like by using link adaptation technology. Here, it is assumed that the aggregation number calculating section 330 determines the second MCS number used in transmission of MAC frames as 11 (16QAM, ½).

The aggregation number calculating section 330 determines an MCS number (first MCS number), which is used in communication using the first channel 20M_ch_a, that is in correspondence with the determined second MCS number (Step S103). The second MCS number may be determined in advance for each MAC frame. In such a case, the aggregation number calculating section 330 determines a first MCS number that is in correspondence with the second MCS number determined in advance.

Here, when the average Pr of received power levels of frames received from the wireless communication device STA3 satisfies the relational expression of Pth1<Pr≦Pth2, it is assumed that the frames are analyzed by the frame analyzing section 350.

Since the destination terminal is the wireless communication device STA3 and the average Pr of received power levels of the frames received from the wireless communication device STA3 satisfies the relationship of Pth1<Pr≦Pth2, the aggregation number calculating section 330 determines the first MCS number that is in correspondence with the second MCS number of 11 as 13 (64QAM, ⅔), based on the MCS correspondence table shown in FIG. 7.

Next, the aggregation number calculating section 330 calculates the aggregation number of the MAC frames that are aggregated for generating an aggregation frame by the aggregation frame generating section 320 based on the first and second MCS numbers, the period in which the channel can be continuously occupied, and the size of the MAC frame (Step S104).

The aggregation number calculating section 330 acquires the period in which the channel can be continuously occupied from a management table that is not shown in the figure. Here, it is assumed that the period in which the channel can be continuously occupied is 3 msec and the size of the MAC frame is 1500 bytes. The aggregation number calculating section 330 acquires 104 Mbps as the communication speed of the first channel 20M_ch_a by using the first MCS number of 13 with reference to the MCS table shown in FIG. 4. In addition, the aggregation number calculating section 330 acquires 108 Mbps as the communication speed of the second channel 40M_ch by using the second MCS number of 11 with reference to the MCS table shown in FIG. 5.

The aggregation number calculating section 330 calculates the number n₂₀ of frames for which transmission can be completed within the period, in which the channel can be continuously occupied, for transmission of the MAC frames using the first channel 20M_ch_a as 26 by using the above-described calculating method. In addition, similarly, the aggregation number calculating section 330 calculates the number n₄₀ of frames for which transmission can be completed within the period, in which the channel can be continuously occupied, for transmission of the MAC frames using the second channel 40M_ch as 27.

The aggregation number calculating section 330 sets one between n₂₀ and n₄₀ which is smaller, that is, 26 as the aggregation number of the MAC frames and transmits the aggregation number to the aggregation frame generating section 320.

Next, the aggregation frame generating section 320 extracts 26 MAC frames, the number of which has been received from the aggregation number calculating section 330 as the aggregation number, from the queue 310 and generates one aggregation frame by aggregating the extracted MAC frames together (Step S105). At this moment, the aggregation frame generating section 320 calculates the size of the aggregation frame and a setting value of the time period required for transmission and adds an aggregation header to the aggregation frame. Then, the aggregation frame generating section 320 transmits the generated aggregation frame to the transmission control section 360.

Next, the transmission control section 360 inquires the channel state managing section 370 of the status of the second channel 40M_ch which is used for transmission of the aggregation frame (Step S106). Then, the transmission control section 360 waits for notification indicating the acquisition of the transmission right for the first channel 20M_ch_a or notification indicating the acquisition of the transmission right for the second channel 40M_ch which is transmitted from the channel state managing section 370.

The channel state managing section 370 determines busy/idle states (channel states) of the first channel 20M_ch_a and the second channel 40M_ch by using the carrier sense information received from the carrier sense section 230 of the physical layer processing unit 200 and the virtual carrier sense information acquired from the MAC layer protocol and tries to acquire transmission right.

When notified of the acquisition of the transmission right for the second channel 40M_ch by the channel state managing section 370 (40 MHz in Step S107), the transmission control section 360 transmits the aggregation frame to the transmission processing part 221 of the second physical layer protocol processing section 220. Then, the transmission processing part 221 of the second physical layer protocol processing section 220 performs a transmission process for the received aggregation frame, and the aggregation frame for which the transmission process has been performed is transmitted from the antenna 100 through the second channel 40M_ch (Step S108).

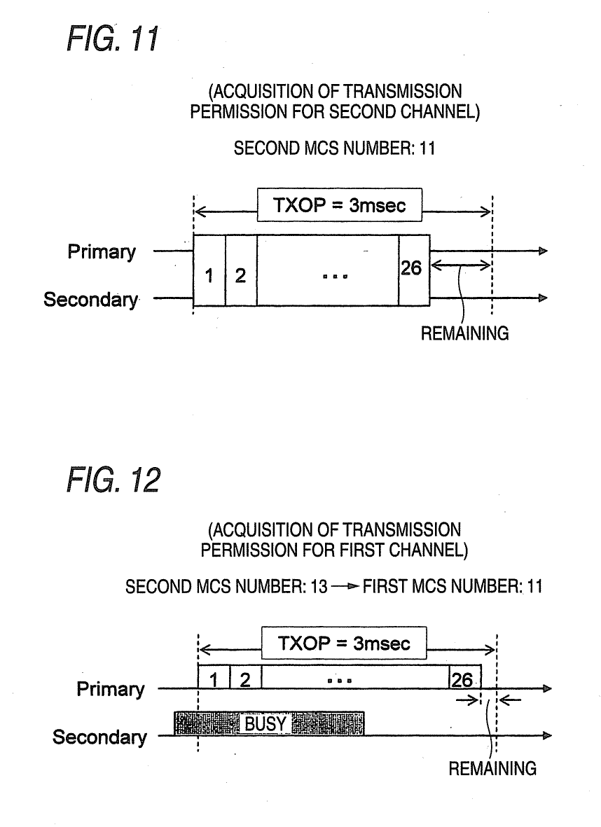

FIG. 11 is a diagram showing a transmission process of the aggregation frame when the transmission right for the second channel 40M_ch is acquired.

When the aggregation frame is transmitted through the second channel 40M_ch, an aggregation frame formed by aggregating 27 MAC frames can be transmitted within the period (TXOP=3 msec) in which the channel can be continuously occupied. In the figure, an aggregation frame formed by aggregating 26 MAC frames is transmitted. Accordingly, a small part of the period in which the channel can be continuously occupied remains. However, the wireless communication device STA1 completes transmission of the aggregation frame within the period, in which the channel can be continuously occupied, without wasting the bandwidth of the second channel 40M_ch and the period, in which the channel can be continuously occupied.

When the notification indicating the acquisition of the transmission right for the first channel 20M_ch_a is received from the channel state managing section 370 (20 MHz of Step S107), the transmission control section 360 performs revision of parameters of the aggregation frame including accessing to the MCS correspondence table shown in FIG. 7 that is stored in the MCS correspondence rule storing section 340 and changing the second MCS number “11” of the aggregation frame to the corresponding first MCS number of 13, for performing transmission by using the first channel 20M_ch_a having the bandwidth of 20 MHz (Step S109).

Then, the transmission control section 360 transmits the revised aggregation frame to the transmission processing part 211 of the first physical layer protocol processing section 210. Then, the transmission processing part 211 of the first physical layer protocol processing section 210 performs a transmission process for the received aggregation frame. The aggregation frame for which the transmission process has been performed is transmitted from the antenna 100 through the first channel 20M_ch_a (Step S110).

FIG. 12 is a diagram showing a transmission process of the aggregation frame in a case where the transmission right for the first channel 20M_ch_a is acquired.

When the aggregation frame is transmitted through the first channel 20M_ch_a, an aggregation frame formed by aggregating 26 MAC frames can be transmitted within the period (TXOP=3 msec) in which the channel can be continuously occupied. In the figure, an aggregation frame formed by aggregating 26 MAC frames is transmitted. Accordingly, the wireless communication device STA1 completes transmission of the aggregation frame within the period, in which the channel can be continuously occupied, without wasting the bandwidth of the first channel 20M_ch_a and the period, in which the channel can be continuously occupied.

As described above, in the wireless communication device according to the embodiment, smaller one of the number of frames that can be transmitted through the first channel having the bandwidth of 20 MHz within the period in which the channel can be continuously occupied and the number of frames that can be transmitted through the second channel having the bandwidth of 40 MHz within the period in which the channel can be continuously occupied is set to the number of MAC frames to be aggregated and the frames are aggregated together in advance before a transmission right for any one of the channels is acquired. Accordingly, the aggregation frame can be transmitted instantly after acquisition of the transmission right for any one of the channels, and transmission of the aggregation frame can be completed within the period in which the channel can be continuously occupied.

In addition, the MCS correspondence table for determining the first and second MCS numbers such that the actual throughputs of the first and second channels are equivalent is used in a process for determining the first MCS number for the first channel having the bandwidth of 20 MHz and the second MCS number for the second channel having the bandwidth of 40 MHz. Accordingly, it can be prevented that the throughput is degraded even in a case where the transmission right for any one between the channels is acquired.

In the above-described embodiment, the MCS correspondence rule storing section 340 has been described to store the MCS correspondence table shown in FIG. 7. However, the MCS correspondence rule storing section 340 may be configured to store a correspondence equation that is used for acquiring the first MCS number based on the second MCS number.

In such a case, in Step S103 shown in FIG. 10, after determining the second MCS number, the aggregation number calculating section 330 calculates a corresponding first MCS number based on the second MCS number and the average of received power levels of frames received from the wireless communication device STA3 that is the destination. At this moment, the first and second MCS numbers are determined such that the actual throughput of frame transmission using the second channel 40M_ch and the effective throughput of frame transmission using the first channel 20M_ch_a are substantially equivalent.

As described above, the first MCS number is calculated based on the second MCS number every time when the aggregation frame is transmitted. Accordingly, the first MCS number can be determined, for example, with the average of received power levels of frames received from the wireless communication device STA3, which is the destination, maintained to a latest value all the time. Accordingly, even in a case where channel environments change markedly, an appropriate first MCS number can be determined.

The wireless communication device STA1, for example, may be implemented by using a general-purpose computer device as basic hardware. In other words, the aggregation frame generating section 320, the aggregation number calculating section 330, the transmission control section 360, the channel state managing section 370, and the frame analyzing section 350 may be implemented by allowing a processor built in the computer device to run a program. In such a case, the wireless communication device STA1 may be implemented by installing the program to the computer device in advance, or may be implemented by storing the program in a storage medium such as a CD-ROM or distributing the program through a network and appropriately installing the program to the computer device. The queue 310 and the MCS correspondence rule storing section 340 may be implemented by appropriately using a memory that is built in the computer device or externally installed to the computer device or a storage medium such as a CD-R, a CD-RW, a DVD-RAM, or a DVD-R.

In addition, the MAC layer processing unit 300, for example, may be implemented not only by using dedicated hardware but also by using a semiconductor integrated circuit such as a large-scale integration (LSI). In such a case, the queue 310, the aggregation frame generating section 320, the aggregation number calculating section 330, the MCS correspondence rule storing section 340, the frame analyzing section 350, the transmission control section 360, and the channel state managing section 370 may be integrated in one semiconductor chip.

It is to be understood that the present invention is not limited to the specific embodiment described above and that the present invention can be embodied with the components modified without departing from the spirit and scope of the present invention. The present invention can be embodied in various forms according to appropriate combinations of the components disclosed in the embodiment described above. For example, some components may be deleted from the configurations as described as the embodiment.

What is claimed is:

1. A wireless communication device that performs transmission and reception of frames by occupying one of two first channels having the same bandwidth or by occupying a second channel including both of the first channels for a given time period, the device comprising:
a determination unit that determines a first status representing whether at least one of the first channels is in a busy state or in an idle state and a second status representing whether the second channel is in a busy state or in an idle state;
an acquisition unit that acquires a transmission right for the first channel or the second channel based on the first status and the second status;
a storage unit that stores relationship information used for determining a relationship between first numbers and second numbers, the first numbers being used for determining a modulation scheme and a coding scheme for transmitting the frame through the first channel, the second numbers being used for determining a modulation scheme and a coding scheme for transmitting the frame through the second channel;
a first determination unit that determines a selected second number used for transmitting the frame through the second channel from among the second numbers;
a second determination unit that determines a selected first number corresponding to the selected second number based on the relationship information;
a first calculation unit that calculates the number of frames that are transmittable through the first channel within the given time period as a first frame number based on a transmission rate that is determined from the selected first number;
a second calculation unit that calculates the number of frames that are transmittable through the second channel within the given time period as a second frame number based on a transmission rate that is determined from the selected second number;
a selection unit that selects smaller one of the first frame number and the second frame number;
an aggregation unit that aggregates frames for the selected frame number selected by the selection unit to generate a single aggregation frame before the acquisition unit acquires the transmission permission; and
a transmission unit that transmits the aggregation frame through one of the first channels or the second channel for which the transmission permission is acquired.

2. The device according to claim 1,
wherein the relationship information is defined in a table.

3. The device according to claim 1,
wherein the relationship information is defined by a relational expression, and
wherein the second determination unit calculates to determine the selected first number corresponding to the selected second number based on the relational expression.

4. The device according to claim 1, wherein the storage unit stores the relationship information for each transmission destination address to which the aggregation frame is transmitted by the transmission unit.

5. The device according to claim 1,
wherein the first numbers are Modulation and Coding Scheme (MCS) numbers that are used for frame transmission using the first channel, and
wherein the second numbers are MCS numbers that are used for frame transmission using the second channel.

6. The device according to claim 1 further comprising:
a reception unit that receives frames from a plurality of wireless communication devices through the first channel or the second channel; and
a second storage unit that stores frame error rates of the frames received by the reception unit for each transmission source address that is included in the received frames, where in the relationship information includes a plurality of relationships between the first numbers and the second numbers,
and
wherein the second determination unit determines the selected first number corresponding to the selected second number based on one relationship among the plurality of relationships which corresponds to a frame error rate of the frame received from a transmission source address that is the same as the transmission destination address included in the aggregation frame to be transmitted.

7. The device according to claim 1 further comprising:
a reception unit that receives frames from a plurality of wireless communication devices through the first channel or the second channel; and
a second storage unit that stores received power levels of the frames received by the reception unit for each transmission source address that is included in the received frames,
wherein the relationship information includes a plurality of relationships between the first numbers and the second numbers,
and
wherein the second determination unit determines the selected first number corresponding to the selected second number based on one relationship among the plurality of relationships which corresponds to a received power level of the frame received from a transmission source address that is the same as the transmission destination address included in the aggregation frame to be transmitted.

8. A method for controlling a wireless communication device that performs transmission and reception of frames by occupying one of two first channels having the same bandwidth or by occupying a second channel including both of the first channels for a given time period, the method comprising:
determining a first status representing whether at least one of the first channels is in a busy state or in an idle state and a second status representing whether the second channel is in a busy state or in an idle state;
acquiring a transmission permission for the first channel or the second channel based on the first status and the second status;
reading relationship information used for determining a relationship between first numbers and second numbers from a storage unit, the first numbers being used for determining a modulation method and an encode method for transmitting the frame through the first channel, the second numbers being used for determining a modulation method and an encode method for transmitting the frame through the second channel;
determining a selected second number used for transmitting the frames through the second channel from among the second numbers;
determining the selected first number corresponding to the selected second number based on the relationship information;
calculating the number of frames that are transmittable through the first channel within the given time period as a first frame number based on a transmission rate that is determined from the selected first number;
calculating the number of frames that are transmittable through the second channel within the given time period as a second frame number based on a transmission rate that is determined from the selected second number;
selecting smaller one of the first frame number and the second frame number;
aggregating frames for the selected frame number to generate a single aggregation frame before acquiring the transmission permission; and
transmitting the aggregation frame through one of the first channels or the second channel for which the transmission permission is acquired.

9. A computer-readable program product for causing a process or of a wireless communication device to perform a process comprising:
determining a first status representing whether at least one of the first channels is in a busy state or in an idle state and a second status representing whether the second channel is in a busy state or in an idle state;
acquiring a transmission permission for the first channel or the second channel based on the first status and the second status;
reading relationship information used for determining a relationship between first numbers and second numbers from a storage unit, the first numbers being used for determining a modulation method and an encode method for transmitting the frame through the first channel, the second numbers being used for determining a modulation method and an encode method for transmitting the frame through the second channel;
determining a selected second number used for transmitting the frames through the second channel from among the second numbers;
determining the selected first number corresponding to the selected second number based on the relationship information;
calculating the number of frames that are transmittable through the first channel within the given time period as a first frame number based on a transmission rate that is determined from the selected first number;
calculating the number of frames that are transmittable through the second channel within the given time period as a second frame number based on a transmission rate that is determined from the selected second number;
selecting smaller one of the first frame number and the second frame number;
aggregating frames for the selected frame number to generate a single aggregation frame before acquiring the transmission permission; and
transmitting the aggregation frame through one of the first channels or the second channel for which the transmission permission is acquired.

10. A semiconductor integrated circuit comprising:
a determination unit that determines a first status representing whether one of two first channels having the same bandwidth is in a busy state or in an idle state and a second status representing whether a second channel including both of the first channels is in a busy state or in an idle state;
an acquisition unit that acquires a transmission permission for the first channel or the second channel based on the first status and the second status;
a storage unit that stores relationship information used for determining a relationship between first numbers and second numbers, the first numbers being used for determining a modulation method and an encode method for transmitting the frames through the first channel, the second numbers being used for determining a modulation method and an encode method for transmitting the frames through the second channel;
a first determination unit that determines a selected second number used for transmitting the frame through the second channel from among the second numbers;
a second determination unit that determines a selected first number corresponding to the selected second number based on the relationship information;
a first calculation unit that calculates the number of frames that are transmittable through the first channel within the given time period as a first frame number based on a transmission rate that is determined from the selected first number;
a second calculation unit that calculates the number of frames that are transmittable through the second channel within the given time period as a second frame number based on a transmission rate that is determined from the selected second number;
a selection unit that selects smaller one of the first frame number and the second frame number;
an aggregation unit that aggregates frames for the selected frame number selected by the selection unit to generate a single aggregation frame before the acquisition unit acquires the transmission permission; and
a transmission unit that transmits the aggregation frame through one of the first channels or the second channel for which the transmission permission is acquired.
